(19) United States
(12) Patent Application Publication
(10) Pub. No.: US 2007/0109578 A1
(43) Pub. Date: May 17, 2007

(54) Operation procedure optimizing method, apparatus and program

(76) Inventor: Tadashi Suzue, Tokyo (JP)

Correspondence Address: CANTOR COLBURN, LLP, 55 GRIFFIN ROAD SOUTH, BLOOMFIELD, CT, 06002, US

(21) Appl. No.: 11/506,094

(22) Filed: Aug. 17, 2006

(30) Foreign Application Priority Data
Nov. 16, 2005 (JP) JP2005-331619

(51) Int. Cl. G06F 3/12

(52) U.S. Cl. 358/1.13

(57) ABSTRACT

There is described an apparatus which makes it possible to revise the consecutive operating procedure information to more effective one. The apparatus includes: a first storing section to store a series of operating procedure information against to an apparatus as time sequential operating information; a control section to apply a modification processing to specific data having redundancy and included in the operating procedure information stored in the storing section, so as to generate modified operating procedure information; and a second storing section to store the modified operating procedure information generated by the control section. The modification processing is to correct the specific data having redundancy so as to ban an implementation of a redundant function originally represented by the specific data and/or to erase the specific data having redundancy from the operating procedure information.

This application is based on Japanese Patent Application No. 2005-331619 filed on Nov. 16, 2005 in Japanese Patent Office, the entire content of which is hereby incorporated by reference.

### BACKGROUND OF THE INVENTION

The present invention relates to an operation procedure optimizing method, an operation procedure optimizing apparatus and an operation procedure optimizing program.

Conventionally, there have been proposed various kinds of technologies to improve the user's availability and maneuverability of an image forming apparatus, such as a copier, a facsimile, a printer, etc., which serves as an operational object. As the representative of such the technologies, an operational panel, in which a display device and a touch panel are integrally incorporated, has been practically employed in the various kinds of image forming apparatuses. When the user changes the setting conditions for the image forming operation, such as density, contrast, etc., by operating the touch panel, the operational keys, etc., which are included in the operating section, the hardware processing and the software processing of the image forming apparatus are controlled on the basis of the setting conditions changed by the user, so as to form an image, which complies with the setting conditions desired by the user, on a recording medium to be outputted.

Further, there has been devised the system in which the remote-control operation of the image forming apparatus is possible through the network. Concretely speaking, for instance, Patent Document 1 (JP-3042655, Official Gazette of Japanese Patent) sets forth the system in which the remote-control operation of the image forming apparatus is achieved by displaying the operational keys on the display screen of the workstation and transmitting the command signals, corresponding to the operational keys operated through the mouse cursor by the user, to the operational section of the image forming apparatus through the network. In addition, for instance, Patent Document 2 (JP-3327566, Official Gazette of Japanese Patent) sets forth the system in which the coordinate data of the position clicked in the computer screen is transmitted to the copier, and the copier determines the operation designated by the computer from the coordinate data received from the computer so as to conduct the operation concerned. By recording the command signals corresponding to the operating keys and the operating information, such as a coordinate position clicked by the user, etc., in time series, it is possible to reproduce the operating procedure once conducted.

However, when all of the operating information conducted for the apparatus, such as the image forming apparatus, etc., are recorded, since the contents of the operations erroneously conducted are also included in the operating information to be recorded, there have been also included in the operating procedure such the contents of erroneous operations unnecessary for the reproducing operation.

### SUMMARY OF THE INVENTION

To overcome the abovementioned drawbacks in conventional apparatus, it is an object of the present invention to provide an apparatus, which makes it possible to revise the consecutive operating information to more effective one.

Accordingly, to overcome the cited shortcomings, the abovementioned object of the present invention can be attained by an operating procedure optimizing method, an apparatus and a computer program described as follow.
(1) An operating procedure optimizing method, comprising: storing a series of operating procedure information against to an apparatus as time sequential operating information; and applying a modification processing to specific data having redundancy and included in the operating procedure information stored in the storing step, so as to generate modified operating procedure information.
(2) An apparatus, comprising: a first storing section to store a series of operating procedure information against to an apparatus as time sequential operating information; and a control section to apply a modification processing to specific data having redundancy and included in the operating procedure information stored in the storing section, so as to generate modified operating procedure information.
(3) A computer program for executing a modification processing for modifying an operating procedure against to an apparatus, comprising the functional steps of: storing a series of operating procedure information against to an apparatus as time sequential operating information; and applying the modification processing to specific data having redundancy and included in the operating procedure information stored in the storing step, so as to generate modified operating procedure information.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows an example of a brief configuration of a remote operating system;

FIG. 2 shows an example of a remote operating screen;

FIG. 3 shows an example of a functional configuration of a remote operating system embodied in the present invention;

FIG. 4 shows a flowchart for explaining a script recording processing;

FIG. 5 shows an example of a data structure of script data;

FIG. 6 shows an example of a data structure of script data after the optimization processing is applied; and

FIG. 7 shows a flowchart for explaining a readout processing of script data.

### DETAILED DESCRIPTION OF THE PREFERRED EMBODIMENT

<Summary of Remote Operating System>

Referring to the drawings, a remote operating system embodied in the present invention will be detailed in the following.

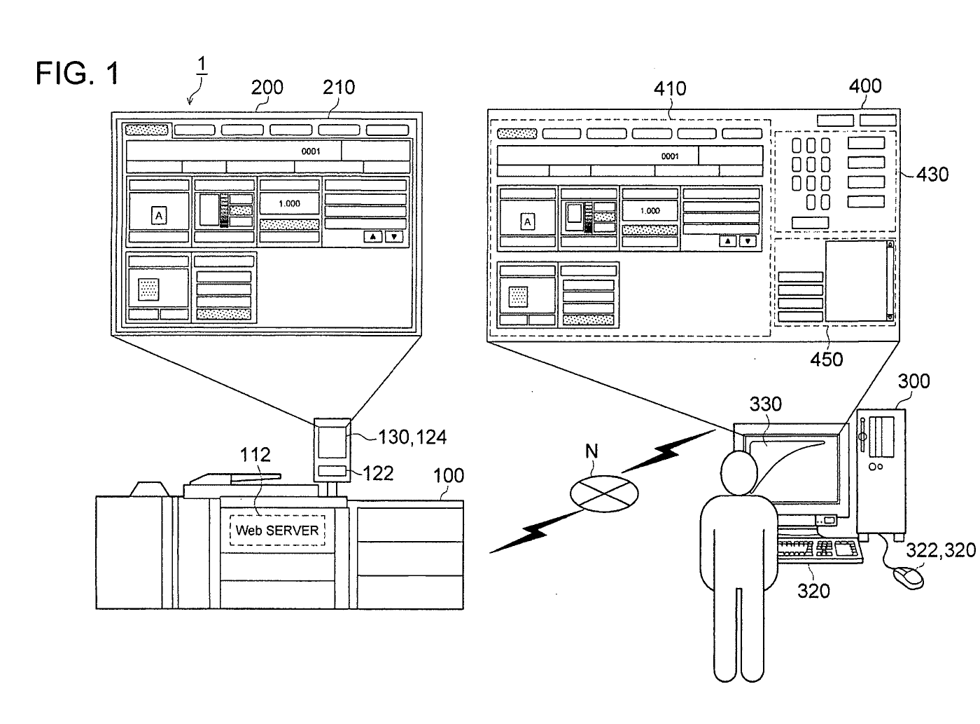

FIG. 1 shows an example of a brief configuration of a remote operating system 1. As shown in FIG. 1, the remote operating system 1 is constituted by a copier 100 serving as an apparatus of remote operating object and a remote terminal device 300, and is communicatively coupled to them through a communication network N including hard-wired and/or wireless communication paths. Although the present embodiment will be detailed by exemplifying a copier serving as an example of the image forming apparatus in the following, it is needless to say that another image forming apparatus, such as a facsimile, a printer, etc., is also applicable in the present invention.

As shown in FIG. 1, the copier 100 is provided with a display section 130 over that a touch panel 124 is mounted and a hard keys section 122. The user can conduct a changing operation of various kinds of setting conditions, an instructing operation of the copy commencement, etc. in regard to the copier 100, by pushing down the hard keys section 122 or touching the touch panel 124. A main operating panel screen 210 from which various kinds of setting conditions can be inputted into the copier 100 and a main operating screen 200, which includes an operating status, etc., are displayed on the display section 130.

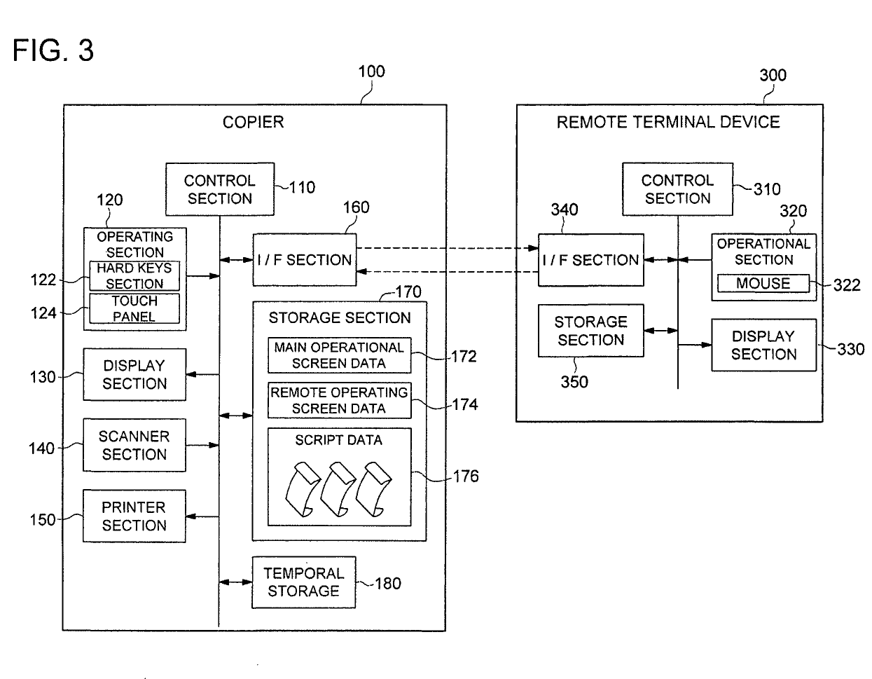

Further, the copier 100 also has a function as a Web server 112. When the copier 100 is coupled to the communication network N based on the communication protocol, such as the TCP/IP, etc., the Web server 112 can be accessed from an external device. In response to the requesting command sent from the remote terminal device 300 serving as the accessing external device, the Web server 112 transmits remote operating screen data 174 (refer to FIG. 3) to the remote terminal device 300 so as to display a remote operating screen 400 including a screen same as the main operating panel screen 210.

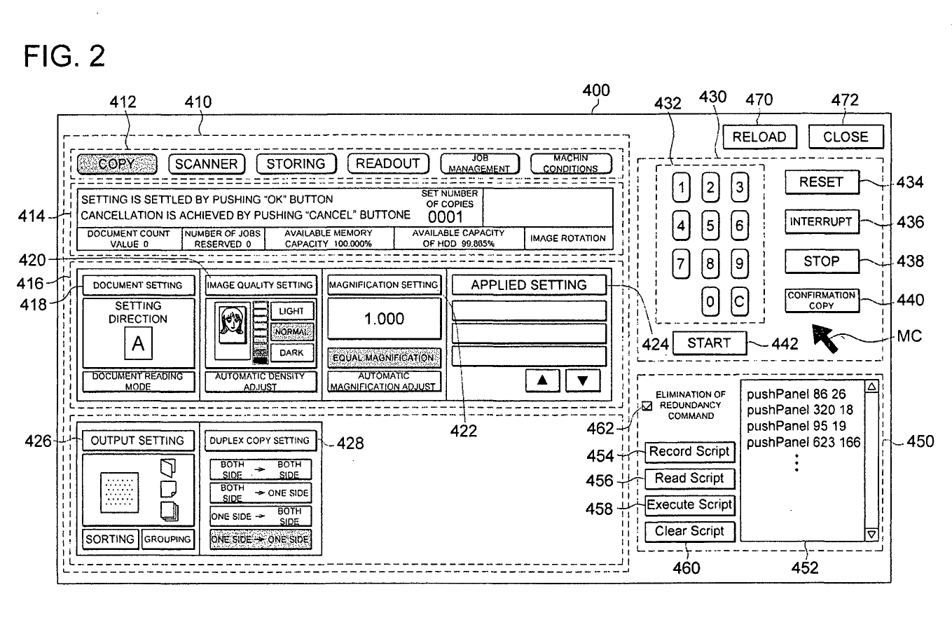

The remote terminal device 300 serves as a client terminal device for remote-controlling the operations of the copier 100, and for instance, is constituted by a personal computer, a PDA (Personal Digital Assistant), etc. As shown in FIG. 1, the remote terminal device 300 is provided with an operational section 320 having a keyboard and a mouse 322, and a display section 330. Further, the remote terminal device 300 has a function as the Web browser. When the remote terminal device 300 is coupled to the communication network N based on the communication protocol, such as the TCP/IP, etc., the remote terminal device 300 displays the remote operating screen 400 shown in FIG. 2 on the display section 330, based on the remote operating screen data 174 transmitted from the copier 100.

As shown in FIG. 2, the remote operating screen 400 includes a remote setting panel 410, a hard keys panel 430 and a script panel 450. The contents of the remote setting panel 410 are the same as those of the main operating panel screen 210 to be displayed at the copier 100, namely, the remote setting panel 410 is constituted by a tab button 412, an operating status indication area 414 and an individual item setting area 416. The tab button 412 is used for switching the display of setting items, which are classified into various kinds of functions. The operating status indication area 414 is used for displaying the operating contents currently implemented in the copier 100, the current using status of the copier 100, etc. The individual item setting area 416 is used for setting the individual items included in the function switched by the tab button 412.

In the remote setting panel 410 shown in FIG. 2, the copy function is selected by using the tab button 412, and a document setting button 418 for setting the direction of the image to be read, etc., an image quality setting button 420 for setting a density of the copy, a magnification setting button 422 for setting a magnification, an applied setting button 424 for setting applied function, an output setting button 426 for setting the post processing (such as a staple processing, a sort processing, etc.) to be applied to the recorded paper sheets and a duplex copy setting button 428 for setting the duplex copy mode are displayed within the individual item setting area 416. When the user clicks the mouse 322 while adjusting a mouse cursor MC onto each of the abovementioned setting buttons, the setting panel corresponding to each of the setting items is displayed in the Windows format, so that the user can conducts the detailed setting operation on the setting panel displayed.

The hard keys panel 430 is displayed as a group of buttons copied from the hard keys section 122 of the copier 100, and includes a numerical button 432, a reset button 434 for resetting the setting contents, an interrupt button 436 for activating the interrupt processing during the copy operation, a stop button 438 for stopping the copy operation, a confirmation copy button 440 for activating the confirmation copy operation and a start button 442 for commencing the copy operation.

The user can conduct setting operations at the time of the copy operation by touching the various kinds of buttons displayed on the main operating panel screen 210 of the copier 100 side, and can conduct the copy commencing operation or the copy resetting operation by pushing down the corresponding buttons included in the hard keys section 122. On the other hand, the other user located at the site of the remote terminal device 300 can conducts the operations same as those conducted by touching the various kinds of buttons displayed on the main operating panel screen 210 of the copier 100 side or by pushing down the buttons included in the hard keys section 122, by remote-controlling the copier 100 and clicking the various kinds of buttons included in the remote setting panel 410 and the hard key panel 430.

Every time when the user clicks any one of the buttons displayed on the remote operating screen 400, the operation information representing the content of the operation concerned are sequentially recorded one by one as the time sequential domain in the copier 100. In the present embodiment, the operation information mentioned in the above is defined as script data 176 (refer to FIG. 3). The script data 176 make it possible to reproduce the consecutive operations conducted by the user so as to resume the various kinds of setting conditions set by the user.

The script panel 450 serves as an operational panel for controlling the script data 176, and includes a script indicating area 452 for indicating the contents of the script data 176, a recording button 454, a readout button 456, an implementation button 458, a clear button 460 and an “elimination of redundancy command” check box 462.

After clicking the recording button 454, the user conducts the various kinds of setting operations by clicking the buttons included in the remote setting panel 410 and/or the hard key panel 430. Every time when the user clicks any one of the buttons mentioned in the above, the operating information are stored in the copier 100 and, at the same time, displayed on the script indicating area 452. At the time when the user clicks the start button 442, the recording operation of the operating information is finalized, and the completed script data 176 is stored in the storage section 170 of the copier 100 (refer to FIG. 3). Then, when the user clicks the readout button 456, the control section 110 reads out the script data 176 stored in the copier 100. Successively, when the user clicks the implementation button 458, the control section 110 reproduces the consecutive operations once conducted by the user, so as to resume the various kinds of setting conditions acquired by conducting the consecutive operations. The clear button 460 is used for erasing the script data 176 already stored and/or the script data 176 currently stored from the copier 100.

The “elimination of redundancy command” check box 462 is utilized for selecting whether or not the redundancy of the script data 176 should be eliminated. Hereinafter, the redundancy of the script data 176 is defined as a fact that the script data 176 includes a nonsense portion as the operation procedure, such as erroneous operating information, etc., or a portion, which is rewritable to more simpler operating information.

Still further, a reload button 470 and a close button 472 are displayed in the area located at the upper right position of the remote operating screen 400. When the user clicks the reload button 470, the remote terminal device 300 sends the transmitting request of the newest remote operating screen data 174 to the copier 100, so as to revise the display of the remote operating screen 400. The close button 472 is used for closing the remote operating screen 400.

<Configuration of Remote Terminal Device>

FIG. 3 shows an example of the functional configuration of the remote operating system 1. At first, the functional configuration of the remote terminal device 300 will be detailed in the following. As shown in FIG. 3, the remote terminal device 300 is provided with a control section 310, the operational section 320, the display section 330, an I/F section 340 and a storage section 350.

The control section 310 is constituted by CPU (Central Processing Unit), ROM (Read Only Memory), RAM (Random Access Memory), etc., and implements the various kinds of processing based on the predetermined programs in response to the inputted command signals, and also conducts the input/output operations of data and command signals from/to each of the functional sections, so as to totally manage and control the remote terminal device 300. Concretely speaking, in response to operational signals inputted from the operational section 320, the CPU reads out a program stored in the ROM or the storage section 350, and then, displays the results of the processing executed according to the program concerned.

The operational section 320 is provided with the keyboard, having cursor keys, ten keys, various kinds of function keys, etc., and the pointing device, such as the mouse 322, etc., so as to output the push-down signal of the pushed key, the positional signals of the mouse 322, etc. to the control section 310.

The display section 330 is constituted by a CRT (Cathode Ray Tube), a LCD (Liquid Crystal Display), etc. so as to display various kinds of screens based on the display data inputted from the control section 310.

The I/F section 340 serves as a functional section for coupling the remote terminal device 300 to the communication network N so as to conduct the data communication through the communication network N. The I/F section 340 is provided with a modem, a LAN (Local Area Network) interface, a USB port, etc.

The storage section 350 serves as a functional section for conducting the data read/write operations for the storage medium, such as, for instance, a CD-ROM, a memory card, a hard disc drive, etc. A magnetic storage medium, an optical storage medium, a semiconductor storage medium, etc. can be employed as the abovementioned storage medium, which stores application programs, various data processed by executing various kinds of processing programs, etc.

The control section 310 serves as the Web browser to display the remote operating screen 400 on the display section 330. In addition, based on the positional signals of the mouse 322, outputted from the operational section 320, the control section 310 acquires (x, y) coordinate values of the mouse cursor MC on the remote operating screen 400, and then, transmits the acquired coordinate data to the copier 100 through the I/F section 340 so as to request a transmission of the remote operating screen data 174. Then, when receiving the remote operating screen data 174 transmitted from the copier 100, the control section 310 changes the remote operating screen 400 to new one based on the remote operating screen data 174. According to this operation, the remote terminal device 300 displays the remote operating screen 400 based on the remote operating screen data 174 transmitted by the Web server 112.

<Configuration of Copier>

Next, a functional configuration of the copier 100 will be detailed in the following. As shown in FIG. 3, the copier 100 is provided with the control section 110, an operating section 120, the display section 130, a scanner section 140, a printer section 150, an I/F section 160, a storage section 170 and a temporal storage 180.

The control section 110 is constituted by a CPU (Central Processing Unit), a ROM (Read Only Memory), a RAM (Random Access Memory), etc., in order to execute processing based on the predetermined programs in response to the command signals inputted from the operating section 120 and conduct input/output operations of the instructions and data from/to each of the functional sections, so as to totally manage and control the copier 100.

The operating section 120 is provided with the hard keys section 122 including various kinds of keys, such as numeral keys, a start key, a reset key, etc., to output the push-down signals corresponding to the pushed-down keys in the hard keys section 122 to the control section 110. Further, the operating section 120 is also provided with a touch panel integrally formed with the display section 130, so as to detect a position on the touch panel 124 touched by the finger tip of the user or a touch pen and to output the detected positional signal to the control section 110.

The display section 130 is constituted by the CRT, the LCD, etc., over which a transparent touch panel is mounted. In response to instructions sent from the control section 110, the display section 130 displays various kinds of screens to be outputted. Concretely speaking, the display section 130 displays the main operating screen 200 based on main operational screen data 172 stored in the storage section 170. The control section 110 compares the positional signals, representing the touched position on the touch panel 124, with the main operational screen data 172, in order to determine which button included in the main operating screen 200 was touched by the user. Then, the control section 110 executes the processing corresponding to the button pushed by the user, for instance, changing the copy setting, revising the main operational screen data 172, etc.

The scanner section 140 has a function for reading an image residing on the document, put on the document stacking tray, to generate image data representing the image. Concretely speaking, when the start key in the operating section 120 is pushed, the scanner section 140 conveys the document put on the document stacking tray to the contact glass at which the light, originally emitted from a light source and irradiated onto the document, is reflected from the document, and then, the reflected light travels into the CCD (Charge Coupled Device) image sensor through a mirror unit and the focusing lens so as to read the reflected light as the image data.

The printer section 150 has a function for forming an image onto a transfer material. Concretely speaking, in the printer section 150, the photoreceptor drum is exposed by scanning the laser beam emitted from the exposing section and modulated on the basis of the image data read by the scanner section 140 so as to form a latent image on it. Successively, in the developing section, toner particles are absorbed onto the photoreceptor drum, and then, the toner image formed on the photoreceptor drum is transferred onto the transfer material. Finally, in the fixing section, the toner image is fixed onto the transfer material by applying heat and pressure onto the transfer material with the toner image.

The I/F section 160 is provided with a modem, a LAN interface, a USB, etc., and has a function for coupling the copier 100 to the communication network N so as to conduct the data communicating operations.

The storage section 170 serves as a functional section for conducting the data read/write operations for the storage medium, such as, for instance, a VRAM (Video Random Access Memory), a CD-ROM, a memory card, a hard disc, etc. A magnetic storage medium, an optical storage medium, a semiconductor storage medium, etc. can be employed as the abovementioned storage medium, which stores application programs, various data processed by executing various kinds of processing programs, the image data read by the scanner section 140, setting contents of the copy function set by the user, etc. Further, as shown in FIG. 3, the storage section 170 stores the main operational screen data 172, the remote operating screen data 174, the script data 176 in it.

The main operational screen data 172 serve as image data (for instance, in the form of HTML) for displaying the main operating screen 200 including the main operating panel screen 210 and the detailed setting panel, etc. When any one of the buttons on the main operating panel screen 210 is pushed, or any one of the buttons on the remote setting panel 410 of the remote terminal device 300 is clicked, the control section 110 generates the main operational screen data 172 so as to revise it as new data. Further, based on the revised main operational screen data 172, the main operating screen 200, in which the detailed setting panel overlaps the main operating panel screen 210, is displayed.

The remote operating screen data 174 serve as image data (for instance, in the form of HTML) for displaying the remote operating screen 400 on the remote terminal device 300. The control section 110 generates image data sets for displaying the hard key panel 430 and the script panel 450, and then, generates the remote operating screen data 174 by combining and synthesizing the generated image data sets with the main operational screen data 172.

Receiving the coordinate data from the remote terminal device 300, the control section 110 compares the (x, y) values, represented by the received coordinate data, with the remote operating screen data 174, so as to detect the position clicked on the remote operating screen 400. Then, when the control section 110 determines that a button displayed on the remote setting panel 410 is clicked, the control section 110 generates the main operational screen data 172 for displaying the detailed setting panel corresponding to the clicked button on the main operating panel screen 210 so as to revise it as new data. While, when the control section 110 determines that a button displayed on the hard key panel 430 is clicked, the control section 110 deems that the corresponding hard-key button on the hard keys section 122 is pushed down, and conducts the processing operation corresponding to the hard-key button concerned (for instance, the commencement or the reset of the copy), and further, generates the main operational screen data 172 for displaying the operating status indication area 414 so as to revise it as new data.

At the same time when revising the main operational screen data 172 in response to the user's operational input, the control section 110 also revises the remote operating screen data 174, based on the revised main operational screen data 172, and then, transmit the revised remote operating screen data 174 to the remote terminal device 300, in order to make the remote terminal device 300 revise the display of the remote operating screen 400. For this purpose, the remote terminal device 300 can display the remote operating screen 400 including the remote setting panel 410 which is the same as the main operating panel screen 210, based on the remote operating screen data 174, while the copier 100 displays the main operating panel screen 210 based on the main operational screen data 172.

The script data 176, being operating procedure information, serve as a data table in which the consecutive operations to be conducted in the remote terminal device 300 of the user are recorded as the operating procedure information in the time domain series. Based on the coordinate data received from the remote terminal device 300, the control section 110 determines which position in the hard key panel 430 or the remote setting panel 410 is clicked, and then, cumulatively stores the determined results one by one in order of the time series as the operating information in the form of the “command argument”.

For instance, the operating information of “key STOP” represent the event that the stop button 438 on the hard key panel 430 is clicked, while the operating information of “pushpanel 86 26” represent the event that the position, at which coordinate values are x=“86”, y=“26” in the remote setting panel 410, is clicked.

Since the control section 110 can sequentially read out the operating information stored in the script data 176 in order to conduct the processing corresponding to the operation represented by the operating information concerned, it becomes possible to reproduce the user's consecutive operations stored in the script data 176 concerned. Accordingly, it is also possible to reproduce the copy conditions established previously by the user.

The temporal storage 180 serves as storage for temporarily storing various kinds of data. For instance, before storing the consecutive operating information in the storage section 170 as the script data 176, the temporal storage 180 temporarily retains the consecutive operating information in it during the remote operations from the remote terminal device 300. Further, when reproducing the operating information based on the script data 176, the temporal storage 180 temporarily retains the script data 176 read from the storage section 170.

<Concrete Operations of Remote Operating SYSTEM>

Next, concrete operations of remote operating system 1 will be detailed in the following.

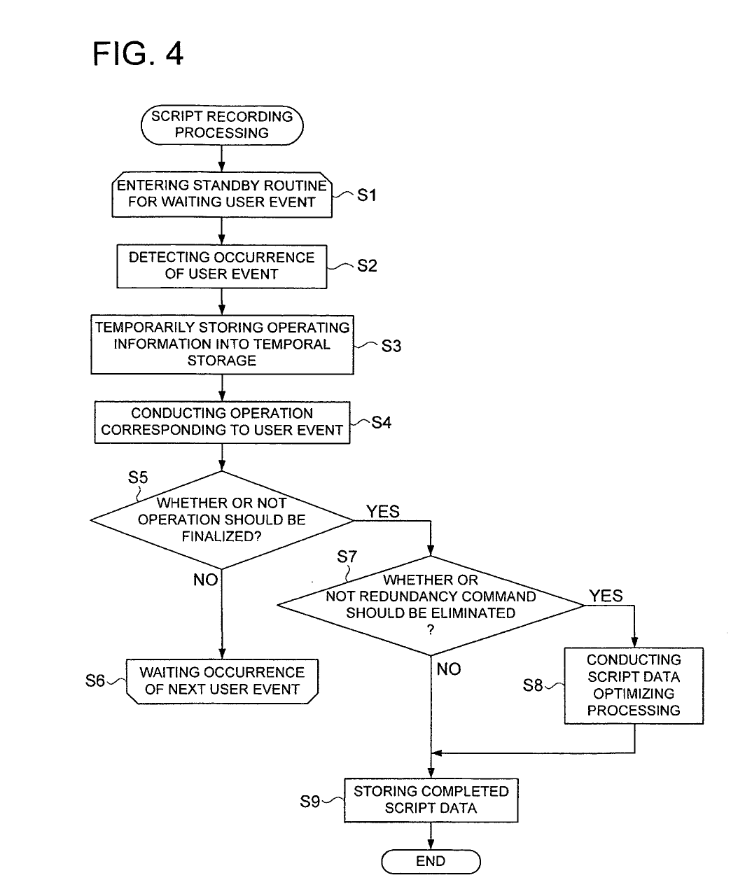

Initially, referring to FIG. 4, the script recording processing will be detailed in the following. The script recording processing is executed on the basis of the script recording program stored in the ROM of the control section 110 or the storage section 170. When the control section 110 of the copier 100 determines that the recording button 454 in the script panel 450 is clicked from the coordinate data transmitted from the remote terminal device 300, the control section 110 reads out the script recording program in order to commence the script recording processing based on the program concerned.

As shown in FIG. 4, the control section 110 enters the standby routine for the user event, so as to wait an occurrence of the user event (Step S1). Hereinafter, the user event is defined as an event caused by an operating action conducted by the user. Concretely speaking, the user event would be a reception of the coordinate data transmitted from the remote terminal device 300 as a result of an action for clicking the mouse 322.

Detecting the occurrence of the user event (Step S2), the control section 110 determines the operation conducted by the user in the remote terminal device 300 side, from the coordinate data received during the user event, so as to temporarily store the operating information, representing the operation conducted by the user, into the temporal storage 180 (Step S3).

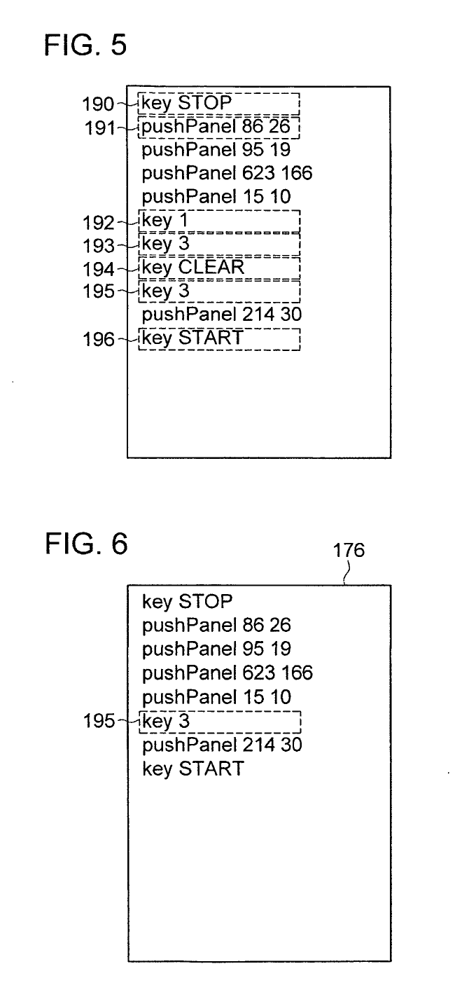

For instance, when the user clicks the stop button 438 in the remote terminal device 300 side, the coordinate data of the mouse cursor MC on the stop button 438 are transmitted to the copier 100. The control section 110 of the copier 100 determines that the received coordinate data represents a position on the hard key panel 430 and stores the operating information 190 shown in FIG. 5 into the temporal storage 180. As well as the above, when the user clicks the start button 442 in the remote terminal device 300 side, the coordinate data of the mouse cursor MC on the start button 442 are transmitted to the copier 100. The control section 110 of the copier 100 determines that the received coordinate data represents a position on the hard key panel 430 and stores the operating information 196 shown in FIG. 5 into the temporal storage 180.

Further, when the user clicks any one of the buttons on the remote setting panel 410, the coordinate data of the mouse cursor MC on the button clicked by the user are transmitted to the copier 100. The control section 110 of the copier 100 compares the received coordinate data with the remote operating screen data 174, so as to determine that the clicking operation for the remote setting panel 410, equivalent to the touching operation for the main operating panel screen 210, is conducted, and the operating information shown in FIG. 5 is stored in the temporal storage 180.

Successively, the control section 110 revises the main operational screen data 172 and the remote operating screen data 174 corresponding to the user event, to transmit an operational instruction (for instance, a revision of copy setting, such as, a magnification setting, a number of copies setting, a document size setting, etc., and a copy start) to each of functional sections (Step S4).

Then, at the time when the control section 110 determines that the received coordinate data represent the position of the start button 442, the control section 110 determines that the operation should be finalized (Step S5). Incidentally, it is also applicable that the abovementioned decision for finalizing the operation is made by determining whether or not a recording stop button, for instance, which is equipped on the script panel 450, is clicked.

When determining that the operation should be continued (Step S5; No), the control section 110 wait an occurrence of the next user event in the standby state (Step S6), and repeat the processing in the standby routine from Step S1 to Step S6, so as to store the operating information one by one in time series into the temporal storage 180.

While, when determining that the operation should be finalized (Step S5; Yes), the control section 110 determines whether or not the “elimination of redundancy command” check box 462 on the script panel 450 is checked (Step S7). When determining that the “elimination of redundancy command” check box 462 on the script panel 450 is checked (Step S7; Yes), the control section 110 conducts a script data optimizing processing (Step S8). Hereinafter, the “script data optimizing processing” is a modification processing which process modify the script data, and it is defined as such a processing that eliminates the redundancy in the script data, such as an elimination of erroneous operating information, a simplification of plurality operating information, an elimination of invalid operating information due to the new operating contents set later, etc.

For instance, the operating information 192, 193 represent the events that the user clicks the “1” and “3” of the numerical button 432 on the hard key panel 430 in the remote terminal device 300, respectively, the operating information 194 represent the event of clicking the “C (clear number of sheets)” and the operating information 195 represent the event of clicking the “3” of the numerical button 432. The abovementioned series of operating information could be regarded as such a case that the user erroneously clicked the “1” and “3” of the numerical button 432 while intending to click the “3” as the number of copy sheets, and then, after clicking the “C (clear number of sheets)” in order to clear the wrong number of copy sheets (being 13 sheets in this case), the user newly clicked the “3” as the correct number of copy sheets. Namely, the operating information 192-194 are unnecessary information in this case. Accordingly, by conducting the optimizing processing, the script data 176 shown in FIG. 6 is generated. The completed script data 176 is stored in the storage section 170 (Step S9).

Incidentally, as an example of the simplification of plural operating information among the optimizing processing, it could be considered that, with respect to the plural operations of setting item “A” and setting item “B” settable within the same operating screen, in such the case that the setting item “A” was set in the operating screen concerned, and then, after once shifting to another operating screen and returning to the operating screen concerned, the setting item “B” was set in the same operating screen in the real operation, the real operating information could be changed to such the simplified operating information as if the setting item “A” and the setting item “B” were continuously set in the same operating screen. Further, with respect to the case that the magnification factor can be set in a unit of 0.01, for instance, when the magnification factor should be set at 0.80 by using the up-down key, it is necessary to push-down the down key for 20 times so as to reduce it from 1.00 to 0.80, and each of the push-down operations is recorded in the script data as the operating information corresponding to the each operation. However, if the magnification factor can be also set by designating the numerical value, by changing the operating information as if the magnification factor were set at 0.80 by using the numerical buttons (practically, two times input operations of the “8” and “0”), it becomes possible to eliminate the redundancy of the script data.

Further, as an example of the elimination of invalid operating information due to the new operating contents set later, for instance, it could be considered such a case that, when the “2in1” mode is set in a single-sheet integrating function of the applied function after setting the magnification factor at 0.5 times, the magnification factor is automatically revised to 0.71 times. Accordingly, in this case, since the operating information, representing the fact that the magnification factor was previously set at 0.5 times, is unnecessary, this operating information could be deleted.

When determining that the “elimination of redundancy command” check box 462 on the script panel 450 is not checked in Step S7 (Step S7; No), the script data stored in the temporal storage 180 are stored in the storage section 170 as the script data 176 (Step S9).

Then, the script recording processing is finalized.

When the script data 176 are stored in a state of eliminating the redundancy commands, it becomes possible to store the script data 176 into a storing area having a storage capacity smaller than ever. In addition, it also becomes possible to omit a waste of operations when reproducing the contents of the operations based on the script data 176.

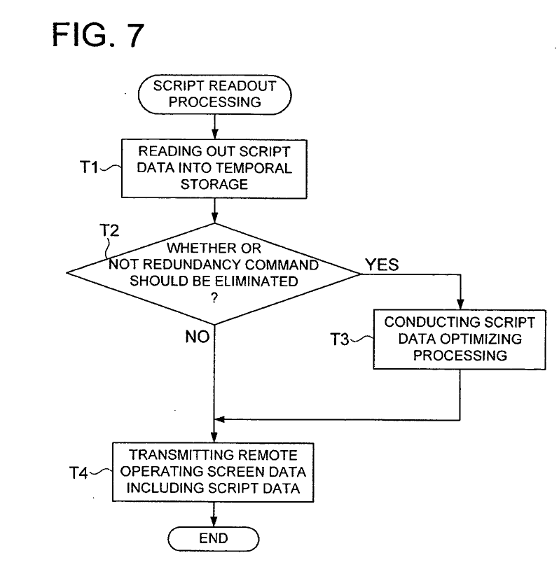

Next, referring to FIG. 7, a script readout processing will be detailed in the following. The script readout processing is conducted on the basis of the script readout program stored in the ROM of the control section 110 or the storage section 170. Determining that the readout button 456 on the script panel 450 is clicked and a single set of script data 176 is selected from the plurality of script data 176, from the coordinate data transmitted from the remote terminal device 300, the control section 110 of the copier 100 reads out the script readout program, so as to commence the script readout processing based on the script readout program concerned.

At first, the control section 110 reads out the script data 176, selected as the readout object, to store them into the temporal storage 180 (Step T1).

Successively, the control section 110 determines whether or not the “elimination of redundancy command” check box 462 is checked (Step T2). When determining that the “elimination of redundancy command” check box 462 is checked (Step T2; Yes), the control section 110 conducts the optimizing processing of the script data 176 (Step T3). Since the concrete contents of the optimizing processing were already detailed in the script recording processing, the explanation of them is omitted in the following.

Then, the control section 110 generates the remote operating screen data 174 based on the script data to which the optimizing processing is already applied, and transmits the remote operating screen data 174 to the remote terminal device 300 (Step T4). In the remote terminal device 300, the script data, in which the redundancy is eliminated, are displayed on the script indicating area 452 of the script panel 450.

When determining that the “elimination of redundancy command” check box 462 is not checked (Step T2; No), the control section 110 generates the remote operating screen data 174 based on the script data 176 selected as the readout object, and transmits the remote operating screen data 174 to the remote terminal device 300 (Step T4). In the remote terminal device 300, the script data 176 are displayed on the script indicating area 452 of the script panel 450.

Then, the script readout processing is finalized.

When the redundancy commands are eliminated as a result of the script readout processing, it becomes possible to convert the script data stored in advance to the data more effective than ever. Further, it also becomes possible to omit a waste of operations when reproducing the contents of the operations based on the script data 176 concerned.

As described in the foregoing, according to the present invention, by eliminating the redundancy of the script data 176 for the copier 100, it becomes possible to convert the script data 176 to the data more effective than ever.

### MODIFIED EXAMPLES

In the foregoing, the example in which the present invention is applied to the remote operating system 1 has been described. However, the scope of the present invention is not limited to such the remote operating system 1 mentioned in the above. The preferred embodiment could be modified as needed, as described in the following.

For instance, although, in the abovementioned embodiment, the script data 176 are stored in the copier 100 side, it is also applicable that those are stored in the storage section 350 of the remote terminal device 300 side in response to the operations conducted by the user. In this case, by transmitting the script data 176 from the remote terminal device 300 to the copier 100, the control section 110 of the copier 100 can reproduce the operating procedure.

Further, it is also applicable that the script recording program and the script readout program are stored in the remote terminal device 300 side, so that the control section 310 of the remote terminal device 300 implements the script recording processing and the script readout processing.

Still further, it is also applicable that the remote operating system 1 is configured in such a system that a plurality of copiers are coupled to a single remote terminal device 300 through a network. In this case, it is applicable that the script data 176 stored in the remote terminal device 300 can be transferred to the other copier. It is also applicable that the script data 176 can be applied to the plural copiers. However, as in the case that the operating information representing an operation for implementing a function, which is not provided with the copier, are included in the script data 176, for instance, when the operating information representing the staple processing is transferred to the copier, which does not have the stapling function, the copier concerned conducts a alternative processing (for instance, such as a sort processing) or reads out the next operating information, without conducting the staple processing.

Still further, it is also applicable that the remote operating system 1 is provided with a plurality of remote terminal devices. In this case, the copier 100 stores plural sets of script data 176 acquired by conducting operating and setting actions in the plurality of remote terminal devices. As a result of the abovementioned configuration, it becomes possible for a separate remote terminal device to reproduce the operations conducted in another remote terminal device.

Still further, it is also applicable that the operating actions conducted by the user at the operating section 120 of the copier 100 are stored in the storage section 170 of the copier 100 as the script data 176. In this case, in Step S2 of the script recording processing shown in FIG. 4, by detecting an occurrence of the user event that the operating section 120 of the copier 100 is operated, the script data 176 can be stored.

As described in the foregoing, according to the present invention, the following effects can be attained.
(1) It becomes possible to revise the consecutive operating information according to the operating procedure of the apparatus to more effective one.
(2) It becomes possible to store the operating procedure information into the storage having a storing capacity ralatively smaller than ever.
(3) It become possible to revise the consecutive operating procedure information stored in advance to more effective one.

While the preferred embodiments of the present invention have been described using specific term, such description is for illustrative purpose only, and it is to be understood that changes and variations may be made without departing from the spirit and scope of the appended claims.

What is claimed is:

1. An operating procedure optimizing method of claim 1,
storing a series of operating procedure information against to an apparatus as time sequential operating information; and
applying a modification processing to specific data having redundancy and included in the operating procedure information stored in the storing step, so as to generate modified operating procedure information.

2. The operating procedure optimizing method of claim 1, further comprising:
storing the modified operating procedure information generated in the applying step.

3. The operating procedure optimizing method of claim 1, specific data having redundancy so as to ban an implementation of a redundant function originally represented by the specific data.

4. The operating procedure optimizing method of claim 1,
wherein the modification processing is to erase the specific data having redundancy from the operating procedure information.

5. The operating procedure optimizing method of claim 1,
wherein the operating procedure information are stored in advance in a storage section, and are read out from the storage section prior to the storing step.

6. The operating procedure optimizing method of claim 1, further comprising:
displaying an operating screen for applying the modification processing to the specific data having redundancy; and
setting conditions for modifying the specific data having redundancy by operating the operating screen.

7. The operating procedure optimizing method of claim 1,
wherein the specific data having redundancy represent at least one of erroneous operating information, information rendering simplification and operation information made to be invalid by an operating content established later on.

8. An apparatus, comprising:
a first storing section to store a series of operating procedure information against to an apparatus as time sequential operating information; and
a control section to apply a modification processing to specific data having redundancy and included in the operating procedure information stored in the storing section, so as to generate modified operating procedure information.

9. The apparatus of claim 8, further comprising:
a second storing section to store the modified operating procedure information generated by the control section.

10. The apparatus of claim 8,
wherein the modification processing is to correct the specific data having redundancy so as to ban an implementation of a redundant function originally represented by the specific data.

11. The apparatus of claim 8,
wherein the modification processing is to erase the specific data having redundancy from the operating procedure information.

12. The apparatus of claim 8,
wherein the operating procedure information are stored in advance in a storage section, and are read out from the storage section before the operating procedure information are stored in the first storing section.

13. The apparatus of claim 8, further comprising:
a display section to display an operating screen for applying the modification processing to the specific data having redundancy;
wherein conditions for modifying the specific data having redundancy can be set by operating the operating screen.

14. The apparatus of claim 8,
wherein the specific data having redundancy represent at least one of erroneous operating information, information rendering simplification and operation information made to be invalid by an operating content established later on.

15. The apparatus of claim 8,
wherein the apparatus is an image forming apparatus.

16. A computer program for executing a modification processing for modifying an operating procedure against to an apparatus, comprising the functional steps of:
storing a series of operating procedure information against to an apparatus as time sequential operating information; and
applying the modification processing to specific data having redundancy and included in the operating procedure information stored in the storing step, so as to generate modified operating procedure information.

17. The computer program of claim 16, further comprising the functional step of:
storing the modified operating procedure information generated in the applying step.

18. The computer program of claim 16,
wherein the modification processing is to correct the specific data having redundancy so as to ban an implementation of a redundant function originally represented by the specific data.

19. The computer program of claim 16,
wherein the modification processing is to erase the specific data having redundancy from the operating procedure information.

20. The computer program of claim 16,
wherein the operating procedure information are stored in advance in a storage section, and are read out from the storage section prior to the storing step.

21. The computer program of claim 16, further comprising the functional steps of:
displaying an operating screen for applying the modification processing to the specific data having redundancy; and
setting conditions for modifying the specific data having redundancy by operating the operating screen.

22. The computer program of claim 16,
wherein the specific data having redundancy represent at least one erroneous operating information, information rendering simplification and information made to be invalid by an operating content established later on.

23. The computer program of claim 16,
wherein the apparatus is an image forming apparatus.
